(19) United States
(12) Patent Application Publication
(10) Pub. No.: US 2005/0041729 A1
(43) Pub. Date: Feb. 24, 2005

(54) DSL modem apparatus and communication control method

(75) Inventors: Nobuhiko Noma, Yokohama-shi (JP); Genzo Takagi, Ageo-shi (JP); Motoyoshi Nagai, Yokohama-shi (JP); Mitsuhiro Araki, Tokyo (JP); Akira Atsuta, Tokyo (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Lrd, Osaka (JP)

(21) Appl. No.: 10/781,678

(22) Filed: Feb. 20, 2004

(30) Foreign Application Priority Data
Aug. 22, 2003 (JP) 2003-299109

(51) Int. Cl. H04B 1/38

(52) U.S. Cl. 375/222

(57) ABSTRACT

A DSL modem apparatus provided at a transmission side in an upstream performs upstream communication using carrier indexes of the same range as a downstream. During an echo canceller learning period, a transmission signal is outputted to a line, via notch filters that cut the signal at a frequency location of a PILOT signal of the downstream. An echo signal is received via notch filters and a coefficient is set by calculating from the training signal of its own apparatus and the echo signal.

### BACKGROUND OF THE INVENTION

1. Field of the Invention

The present invention relates to a DSL modem apparatus and communication control method that can be applied to digital communication using a metallic cable.

2. Description of Related Art

xDSL modem using a currently available telephone line allows high-speed communication employing high frequency signals. An ADSL method, one type of xDSL realizing the high-speed communication, employs a DMT (discrete multi tone) modulation method using a plurality of carriers (sub-carriers) in a wide frequency band.

For example, G.992.1 (G.dmt), which is one of the ADSL standards, divides the frequency band ranging from 25 kHz to 1.1 MHz into 256 carriers (sub-carriers). Index number (#) is assigned to each sub-carrier, numbering from the low frequency carrier. As shown in FIG. 7(a), sub-carriers #32-#255 are generally used for a downstream, i.e., transmission from a center side (exchange side, ATU-C) to a remote side (user side, ATU-R). For upstream transmission from ATU-R to ATU-C, sub-carriers #7-#31 are used. Further, in order to increase the speed of downstream communication, sub-carriers #7-#255 can be used in the downstream communication as shown in FIG. 7(b).

In the method shown in FIG. 7(b), both ATU-C and ATU-R use sub-carriers #7-#31. ATU-R uses an echo canceller in order to prevent an echo from its own transmission signal. When an echo canceller is used, it is necessary to learn about the echo from its own apparatus in advance (e.g., Related Art 1). When ATU-C performs the echo canceller, AT-C transmits sub-carriers #7-#255, as shown in FIG. 8(a), in order to detect the echo of each sub-carrier #7-#255. Transmission from ATU-R during such time would cause interference in sub-carriers #7-#31, therefore, the transmission from ATU-R is stopped. On the other hand, when ATU-R performs the echo canceller learning, sub-carriers of #7-#31 are transmitted as shown in FIG. 8(b) in order to detect the echo of each sub-carrier #7-#31. Transmission of ATU-C is stopped except for sub-carrier #64, which is used by ATU-C for the transmission of a PILOT signal. Since the ATU-R synchronizes with the ATU-C based on the PILOT signal transmitted by ATU-C, the PILOT signal transmission should not be stopped. However, the sub-carrier used for the PILOT signal transmission is #64, which is largely distant from the sub-carriers used by ATU-R, thereby the PILOT signal does not interfere with the echo canceller learning.

[Related Art 1]

Japanese Translation of PCT International Application 2003-521194

However, in an effort to improve the speed of the upstream, using the sub-carriers #7-#255 similar to the downstream communication causes an interference with ATU-R learning the echo canceller. In particular, when ATU-R learns the echo canceller, ATU-C needs to stop the transmission in the frequency band that interferes with the transmission signals of ATU-R. However, when the PILOT signal using sub-carrier #64 is stopped, ATU-R cannot synchronize with ATU-C. Thus, the PILOT signal cannot be stopped. Therefore, because of the interference from the PILOT signal, ATU-R cannot perform a full echo canceller learning, thereby creating an adverse effect to the succeeding data communication.

Accordingly, when an opposing apparatus transmits signals that can interfere with transmission signals from its own apparatus (not limited to PILOT signal of #64), during an echo canceller learning period at ATU-R or ATU-C, it becomes difficult to perform the complete echo canceller learning, thereby creating an adverse effect to the succeeding data communication.

### SUMMARY OF THE INVENTION

The present invention addresses the above-described problems. The purpose of the invention is to provide a DSL modem apparatus and a communication control method that allows a highly accurate echo canceller learning, even when the upstream frequency band used by ATU-R includes PILOT signals transmitted by ATU-C, and enables the downstream communication to utilize the wide range of frequency band, similar to the downstream.

This invention controls the data transmission to be stopped for carrier-indexes for a specific signal, the signal being transmitted by the opposing communication apparatus. Further, a notch unit is provided at a frequency location of the specific signal so that the transmission signal from its own apparatus is cut at the frequency location of the specific signal and at the reception side.

### BRIEF DESCRIPTION OF THE DRAWINGS

The present invention is further described in the detailed description which follows, with reference to the noted plurality of drawings by way of non-limiting examples of exemplary embodiments of the present invention, in which like reference numerals represent similar parts throughout the several views of the drawings, and wherein:

FIG. 1 is a schematic diagram of a communication system according to an embodiment of the present invention;

FIG. 2 is a functional block diagram of a transceiver shown in FIG. 1;

FIG. 3 is a functional block diagram of an AFE portion shown in FIG. 1;

FIG. 4 illustrates a spectrum of an upstream;

FIG. 5 is a sequence chart illustrating the handshake sequence and the first half of the initialization sequence;

FIG. 6 illustrates a spectrum of a downstream;

FIG. 7(a) illustrates carrier indexes used in the upstream and downstream according to G.dmt;

FIG. 7(b) illustrates a state where carrier indexes used for the upstream overlap with the low frequency side of carrier indexes used for the downstream;

FIG. 8(a) illustrates a training signal during an echo canceller learning at a center side;

FIG. 8(b) illustrates a training signal during an echo canceller learning at a remote side; and

FIG. 9 illustrates a state where exactly the same carrier indexes are shared by the upstream and downstream.

### DETAILED DESCRIPTION OF PREFERRED EMBODIMENTS

The embodiments of the present invention are explained in the following, in reference to the above-described drawings.

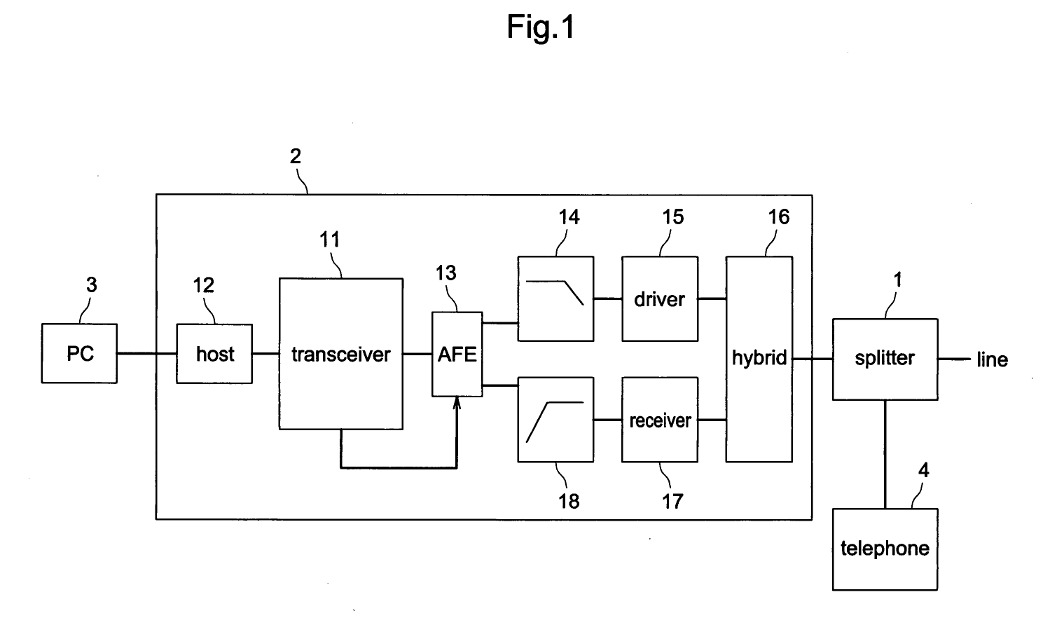

FIG. 1 illustrates a schematic configuration of a communication system of an ATU-R side, according to the present invention. In the communication system as illustrated in FIG. 1, a public phone line or a similar phone line (hereafter referred to as line) is connected to ADSL modem apparatus 2 via splitter 1. Further, user terminal 3 is connected to ADSL modem apparatus 2. When user terminal 3 and telephone 4 share one line, splitter 1 is necessary. However, when telephone 4 is not used, splitter 1 is not needed. It is also possible to have a configuration where user terminal 3 internally installs ADSL modem apparatus 2.

ADSL modem apparatus 2 includes transceiver 11 that executes ADSL communication, and host 12 that controls the entire operation including the one of transceiver 11. At the line side of transceiver 11, units are configured with an analog circuit via analog front end (hereafter referred to as AFE) 13. Driver 15 is connected to a DA converter 13-1 of AFE 13 via analog notch filter 14, so that an analog signal amplified by driver 15 is transmitted to the line via hybrid 16. The analog signal transmitted from the line is received by receiver 17 via hybrid 16, and then input into an AD converter of AFE 13 via analog filter 18. When sampling data is output from the AD converter, AFE 13 outputs the data to transceiver 11.

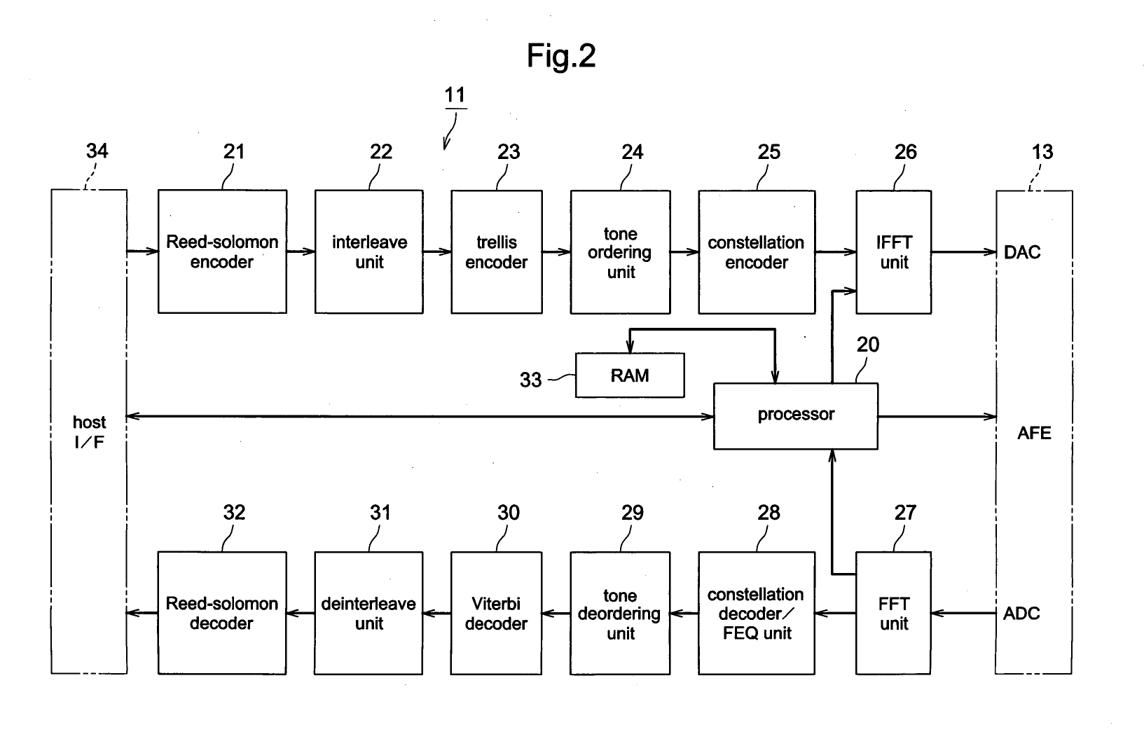

FIG. 2 is a functional block diagram illustrating transceiver 11. Processor 20 has functions to execute handshake and initialization sequences and to control communication during data transmission (SHOWTIME).

The transmission side of transceiver 11 includes Reed-Solomon encoder 21 that adds a redundancy bit for checking error, interleave unit 22 that sorts data to enable a burst error correction during Reed-Solomon decoding, trellis encoder 23 that performs data convolution from a trellis encoding, tone ordering unit 24 that lays out a bit number for each carrier, constellation encoder 25 that allocates topology of the transmission data on constellation coordinates, and IFFT unit 26 that performs an Inverse Fast Fourier Transform (hereafter referred to as IFFT) on data after the constellation encoding process.

The reception process side of transceiver 11 includes FFT unit 27 that performs a Fast Fourier Transform (hereafter referred to as FFT) on sampling data of the received signal, constellation decoder/FEQ unit 28 that decodes data from constellation data of the FFT output signal and corrects a topology on the constellation coordinates, tone de-ordering unit 29 that restores data assigned to each carrier after tone ordering process at the transmission side, Viterbi decoder 30 that performs Viterbi decoding on the received data, de-interleave unit 31 that restores data being resorted by the transmission side, and Reed-Solomon decoder 32 that deletes the redundancy bit added by the transmission side. RAM 33 is a work area of processor 20, which will be used for executing handshake and initialization sequences. Transceiver 11 is connected to host 12 via host interface (I/F) 34.

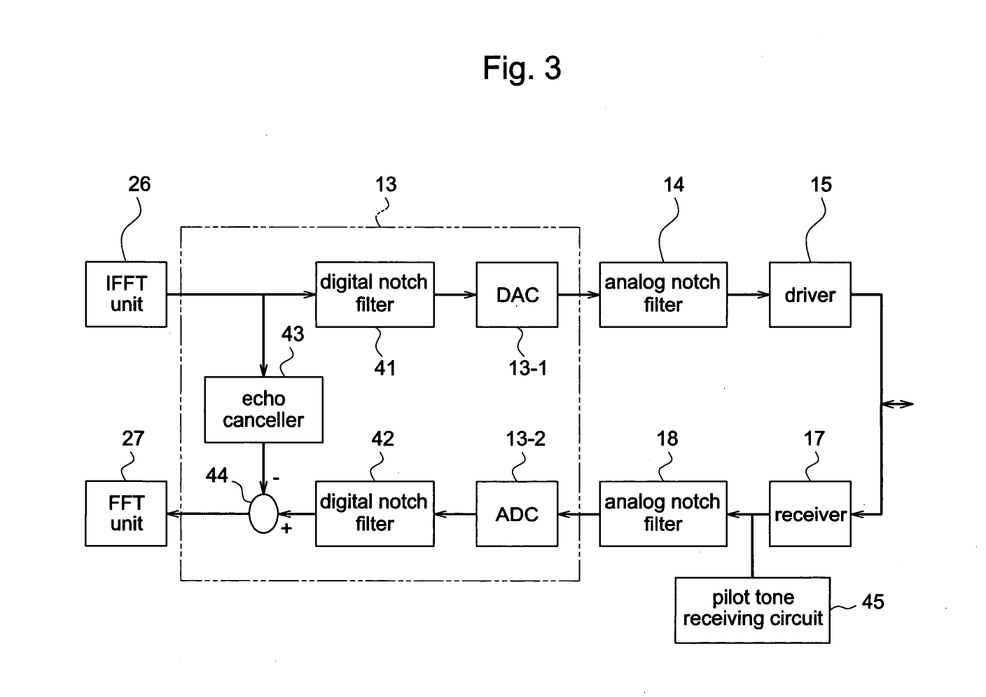

Hereafter, the configuration of AFE 13 is illustrated in detail. FIG. 3 is a block diagram illustrating the internal structure of AFE 13. AFE 13 is provided with an echo canceller function and a digital filter function. Digital notch filter 41 is connected to the input section of DAC 13-1. Digital notch filter 41 has a function to remove signal energy of sub-carrier #64 area that is used by ATU-C for a PILOT signal. In other words, ATU-R transmits signals using sub-carrier in a wide frequency band (e.g., #7-#255) while no energy is applied to sub-carrier #64 (frequency location of the PILOT signal). At the frequency location of #64, transmission data having no signal energy is converted into an analog signal. Further, analog notch filter 14 removes signal energy at the frequency location of sub-carrier #64. This signal energy is affected by signals from the adjacent sub-carriers #63 and #65. In particular, signal energy at each frequency location is diffused into adjacent frequency locations due to the skirt shape of its energy. Therefore, the signal energy at the frequency location of sub-carrier #64 is also affected by signal energy diffused from adjacent frequency locations. However, because of the process at analog notch filter 14, it is possible to remove energy diffused into the frequency location of sub-carrier #64, the energy being generated by adjacent frequency locations.

Furthermore, analog notch filter 18 (located at the output section of receiver 17) and digital notch filter 42 (located at the output section of ADC 13-2) are set in the predetermined frequency band. In addition, a notch unit includes digital notch filter 41, analog notch filter 14, analog notch filter 18, and digital notch filter 42.

The transmission signal output from IFFT unit 26 is diverged and captured by echo canceller 43. In addition, the transmission signal from ATU-C (via receiver 17, analog notch filter 18, and ADC 13-2) and echo component of its own transmission signal (ATU-R) (via IFFT unit 26, digital notch filter 41, DAC 13-1, analog notch filter 14, driver 15, receiver 17, analog notch filter 18, and ADC 13-2) are combined as a reception signal, which is output from digital notch filter 42 at the reception side. The input section of FFT unit 27 is provided with subtracter 44, where the transmission signal of echo canceller 43 is subtracted from the output signal of digital notch filter 42. The result of the subtraction is input to FFT unit 27, as a reception signal.

An ADSL modem apparatus of the center side is connected to ADSL modem apparatus 2 via a metallic cable. The ADSL modem apparatus of the center side has the same configuration as ADSL modem apparatus 2. When the center side is an exchange provided by a communication industry, telephone 4 does not exist.

The following description illustrates in detail the operation according to the present embodiment. When processor 20 is in the initialization sequence, echo canceller 43 performs an echo canceller learning in order to remove the echo signal.

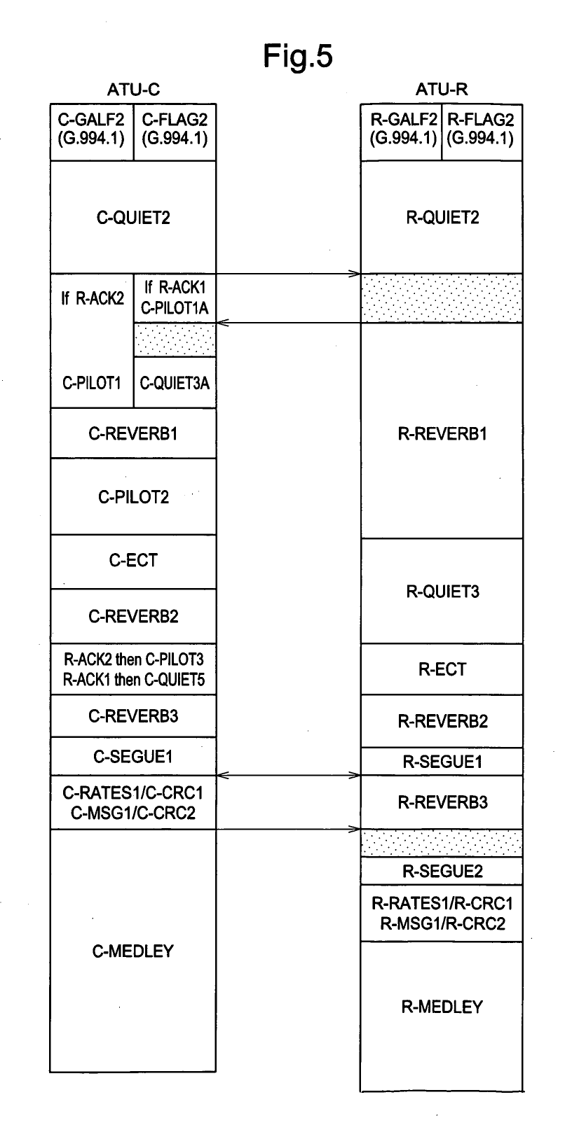

When ATU-R is turned on, the process illustrated in FIG. 5 is performed. First, ATU-C and ATU-R perform the handshake sequence based on G.944.1 and select a mode. Using the example shown in FIG. 5, G.dmt is selected as a mode for the initialization sequence.

When the initialization sequence is initiated, ATU-C transmits C-PILOT1 or C-PILOT1A signal using indexes #64 and #48.

When the initialization sequence is initiated, and when ATU-R detects signal energy at indexes #64 and #48, ATU-R starts a hyperframe synchronization process based on the PILOT signal. After establishing the hyperframe, ATU-R transmits a R-REVERB1 signal.

Upon detecting the R-REVERB1 signal, ATU-C transmits a C-REVERB1 signal to the remote side.

Upon detecting the R-REVERB1 signal, ATU-C sequentially transmits C-REVERB1, C-PILOT2, C-ECT, and C-REVERB2 for a predetermined number of symbols.

Based on the C-REVERB1 or C-REVERB2, ATU-R performs the symbol synchronization.

Upon transmitting C-REVERB3, ATU-C transmits C-SEGUE1, while, upon transmitting R-REVERB2, ATU-R transmits R-SEGUE1 for a plurality of symbols. Thereafter, cyclic prefix data is added to each symbol, since important signals are exchanged that determine parameters during the SHOWTIME. Thus, a RATES signal and an MSG signal with cyclic prefix data are transmitted in order to determine various communication parameters by exchanging communication speed, encoding parameter, and tone-ordering information. Although the following sequence is omitted, both sides confirm the determination of the communication parameters and perform data communication (SHOWTIME).

Further, at the same timing of R-ECT, ATU-R performs the echo canceller learning. As shown in FIG. 5, when ATU-R is in the period of R-ECT, ATU-C stops the transmission of C-REVERB2 signal and transmits C-PILOT3 using sub-carrier #64.

During the R-ECT period, ATU-R performs the echo canceller learning (by echo canceller 43) for the all sub-carriers used during the SHOWTIME. In this embodiment, the upstream uses the same sub-carriers #7-#255 as the downstream. Therefore, processor 20 generates a training signal (transmission data) carried by sub-carriers #7-#255, and inputs the training signal into IFFT unit 26. However, transmission data to be carried by sub-carrier #64 (frequency location of the PILOT signal) is not generated.

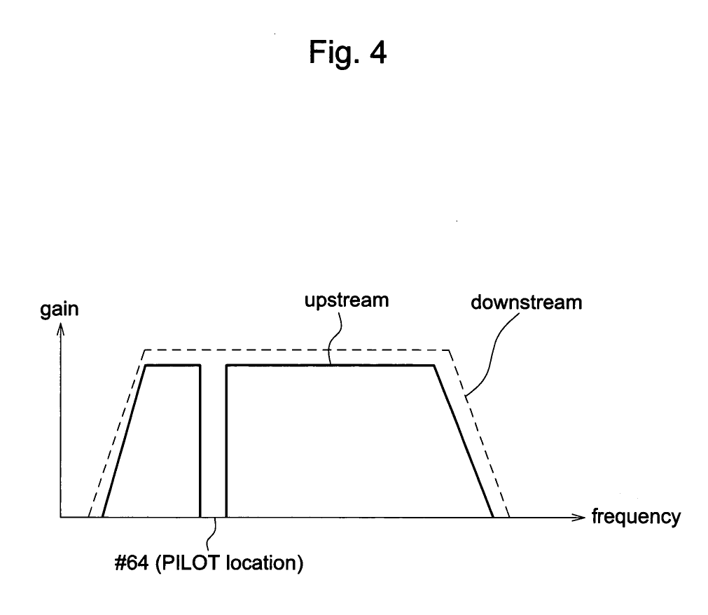

IFFT unit 26 outputs a digital modulation signal (training signal) to digital notch filter 41. The signal is modulated so that transmission data is loaded to each sub-carrier #7-#255 (excluding #64). Since digital notch filter 41 has the filter characteristics as described earlier, signal energy components at the frequency location of #64 are removed from the input signal. Accordingly, a training signal, where the signal energy components at the frequency location of #64 are removed, is generated for #7-#255 (excluding #64). When the training signal is converted into an analog signal by DAC 13-1, analog notch filter 14 filters the signal into a waveform. Especially, due to the frequency characteristics of analog notch filter 14, the signal energy at the frequency location of #64 is removed. Therefore, the training signal having a carrier hole at the frequency location of #64 as shown in FIG. 4. The training signal being configured with sub-carriers #7-#255 and having a carrier hole at frequency location #64 is transmitted to the line via driver 15.

Receiver 17 receives an echo signal of the training signal. The echo signal is given a waveform by analog notch filter 18, and is converted into a digital echo signal at ADC 13-2. The digital echo signal is input to subtracter 44 via digital notch filter 42.

Subtracter 44 is also provided with transmission data (training signal) of #7-#255, the data being transmitted from its own apparatus via echo canceller 43. The difference between the transmission data of its own apparatus and the echo signal is detected, in order to find a most suitable coefficient that can convert transmission data into the echo signal. The above process is referred to as an echo canceller learning.

Receiver 17 cannot find a most suitable coefficient when the transmission signal from the ATU-C interferes with the echo signal originated from its own transmission signal (training signal). Therefore, ATU-C does not transmit signals other than PILOT signals, which is minimally required. The transmission signal from ATU-R has a carrier hole in the frequency location of the PILOT signal (#64), thereby preventing the interference of the PILOT signal with the echo signal. As a result, the echo signal configured with frequencies excluding the frequency of #64 is configured purely with the echo signal of its own transmission signal.

As described above, a most suitable coefficient for converting the transmission data into an echo signal is found, from an echo signal that does not have any interference of the PILOT signal. Then, the coefficient is set in echo canceller 43. Although the transmission data of #64 is subtracted from the PILOT signal, the transmission data at the frequency location #64 has no data. Therefore, the PILOT signal is directly provided to processor 20 via pilot tone receiving circuit 45, and is used by processor 20 for its synchronization.

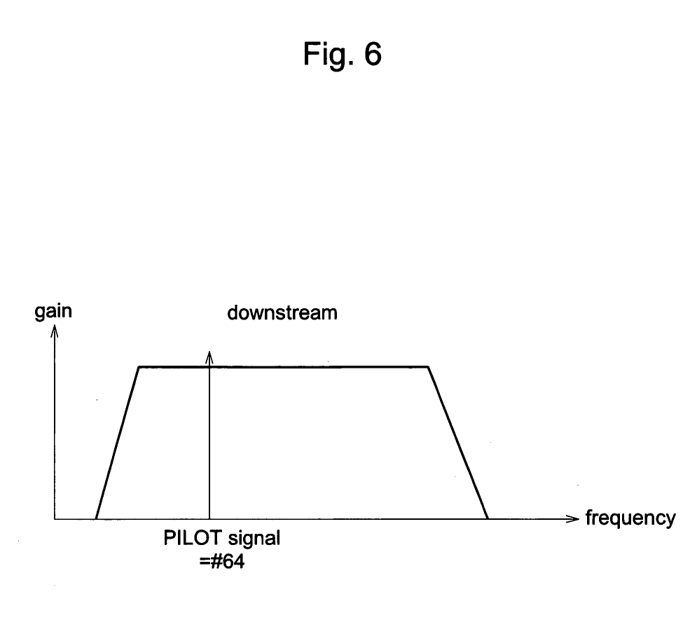

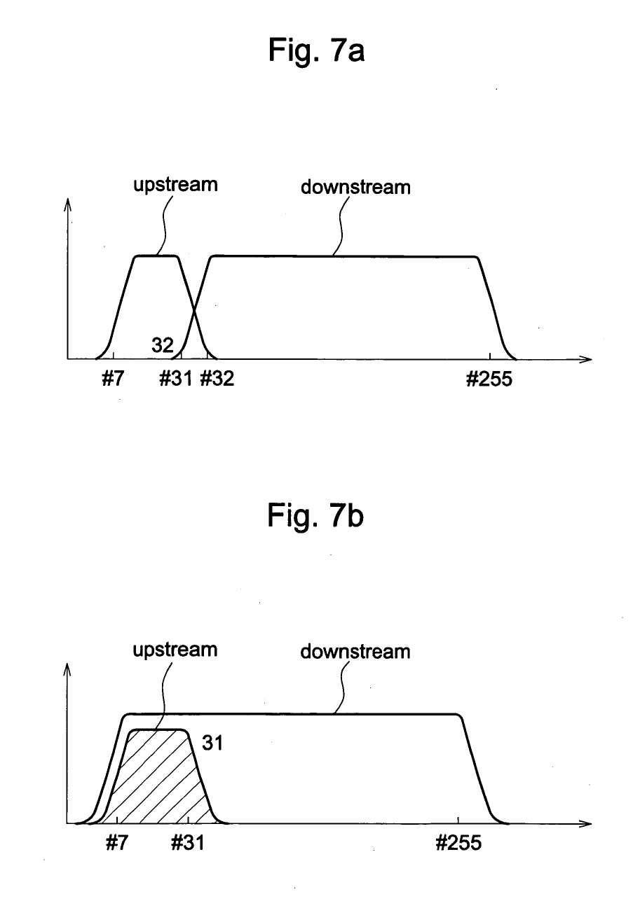

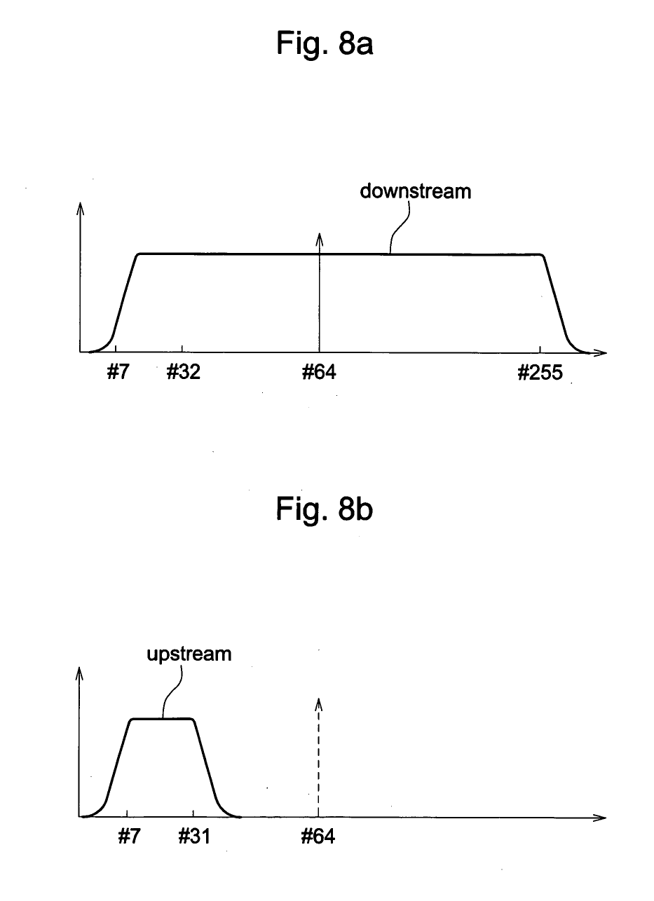

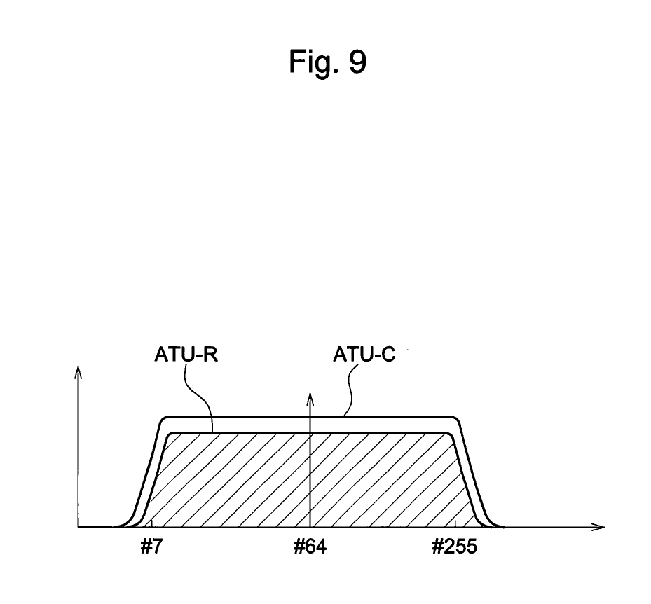

In addition, ATU-C side performs a training of echo canceller 43 during the C-ECT period. As shown in FIG. 5, ATU-R stops the transmission of R-REVERB1 signal during the C-ECT period and has a silence (R-QUIET3). Therefore, as shown in FIG. 6, ATU-C can detect the echo signal without the interference with the remote side signal, even though ATU-C transmits the training signal throughout the transmission band (#7-#255). Similar to the remote side, a most suitable coefficient is calculated from the difference between the echo signal and the transmission signal.

After completing the echo canceller learning, the upstream communication (transmission from ATU-R to ATU-C) is performed in a multi-carrier method, using carriers of carrier indexes #7-#255 and having a carrier hole at the location of the PILOT signal, as shown in FIG. 4. Further, the downstream communication (transmission from ATU-C to ATU-R) is performed using all carriers of #7-#255 as shown in FIG. 6. However, #64 (in the downstream communication) is used for the PILOT signal.

During the initialization sequence and the SHOWTIME, sub-carrier #64 always has no transmission data from the ATU-R (upstream), so that there is a carrier hole in the frequency location of #64. On the other hand, ATU-C transmits the PILOT signal using sub-carrier #64, and transmits the transmission data using other sub-carriers. Accordingly, the echo canceller learning can be accurately performed using the entire frequency band. In addition, the upstream communication can be performed after the echo canceller learning, using the same carrier indexes (except #64) as the downstream, thereby improving the upstream speed.

In the above illustration, a notch filter is provided at the frequency location of the PILOT signal, the signal being transmitted from the center side. However, when there are other specific signals that should not be stopped during the remote side echo canceller learning, a notch filter can be provided at the frequency location of the specific signal in order to perform the echo canceller learning without the echo interference of the specific signal.

In addition, the illustrations were provided for the remote side echo canceller learning. However, when there are other specific signals, transmission of which should not be stopped from the remote side, a notch filter can be provided at the frequency location of the specific signal (similar to the above) in order to perform the echo canceller learning without the echo interference of the specific signal.

Further, although the above illustration used an ADSL modem for the example, the present invention can be applied to other xDSL modems.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

This application is based on the Japanese Patent Application No. 2003-299109 filed on Aug. 22, 2003, entire content of which is expressly incorporated by reference herein.

1. A DSL modem apparatus comprising:
a notch that cuts a signal at a frequency location of a predetermined signal, the signal being transmitted by an opposing communication apparatus;
a transmitter that outputs a transmission signal to a line, the signal having passed through said notch;
a receiver that receives a signal from the line; and
an echo canceller that removes an echo signal from the received signal, the echo signal relating to the transmission signal of its own apparatus, the received signal having passed through said notch.

2. The DSL modem apparatus according to claim 1, wherein a training signal of the echo canceller passes through the notch so that an echo canceller learning is performed under a condition where the transmission signal of its own apparatus does not have an echo at a frequency of the predetermined signal.

3. A DSL modem apparatus provided at a transmission side of an upstream, the apparatus comprising:
a controller that uses a range of carrier indexes for the upstream, the range being the same as a downstream;
a notch that cuts a signal at a frequency location of a PILOT signal of the downstream side;
a transmitter that outputs a transmission signal to a line, said signal having passed said notch;
a receiver that receives a signal from the line; and
an echo canceller that removes an echo signal from the received signal, the echo signal relating to the transmission signal of its own apparatus, the received signal having passed through said notch.

4. A communication control method comprising:
stopping the data communication for a carrier index of a predetermined signal, the signal being transmitted by an opposing communication apparatus; and
cutting an echo of a transmission signal from its own apparatus and a reception signal at a frequency location of the predetermined signal, the reception signal being received from the opposing communication apparatus.

5. A communication control method comprising:
cutting a transmission signal from its own apparatus at a frequency location of a predetermined signal, the predetermined signal being transmitted by an opposing communication apparatus;
cutting a reception signal received from the opposing communication apparatus at the frequency location of the predetermined signal; and
outputting a training signal of an echo canceller under a condition where the transmission signal of its own apparatus does not have an echo at a frequency of the predetermined signal.

6. A communication control method for a DSL communication that uses, for upstream communication, the same frequency band as the entire frequency band of a downstream, the method comprising:
cutting, in the upstream, an echo of a transmission signal and a PILOT signal at a frequency location of the PILOT signal, the PILOT signal being transmitted by an opposing communication apparatus; and
outputting a training signal of an echo canceller under a condition where the transmission signal does not have an echo at a frequency of the PILOT signal.
